(19) United States
(12) Patent Application Publication
(10) Pub. No.: US 2025/0052410 A1
(43) Pub. Date: Feb. 13, 2025

(54) WATERPROOF LAMP STRING

(71) Applicant: FUDE YANG, Dongguan (CN)

(72) Inventor: FUDE YANG, Dongguan (CN)

(21) Appl. No.: 18/234,590

(22) Filed: Aug. 16, 2023

(30) Foreign Application Priority Data
Aug. 7, 2023 (CN) 202322103679.4

(51) Int. Cl. F21V 23/06; F21S 4/10; F21V 31/00

(52) U.S. Cl. CPC F21V 23/06; F21S 4/10; F21V 31/005

(57) ABSTRACT

Provided is a waterproof lamp string, which comprises an electric conductor, a lamp holder component, a light emitting source and a light-transmitting lamp shell, wherein the lamp holder component comprises a lamp holder main body and a lamp holder top cover; the lamp holder main body is provided with a light source mounting part and a lamp shell connecting part, and the light emitting source is embedded in the light source mounting hole of the light source mounting part; the lamp holder main body is provided with a metal terminal, the metal terminal pierces the electrical conductor and is electrically connected with the electrical conductor through a spike part; the lamp holder top cover is fixed at an upper end of the lamp holder main body by ultrasonic sealing welding.

### CROSS-REFERENCE TO RELATED APPLICATIONS

This is a U. S. patent application which claims the priority and benefit of Chinese Patent Application Number 202322103679. 4, filed on Aug. 7, 2023, the disclosure of which is incorporated herein by reference in its entirety.

### TECHNICAL FIELD

The present disclosure relates to the technical field of lamp strings, in particular to a waterproof lamp string.

### BACKGROUND

It is an important activity of Christmas to use Christmas trees for holiday decoration. In order to improve the decoration of Christmas trees, decorations are often hung on Christmas trees, and string lamps have become essential decorations for Christmas.

There are various string lamp structures in the prior art. However, for the existing string lamp structures, there are generally defects such as poor waterproof performance and inconvenient assembly.

### SUMMARY

The purpose of the present disclosure is to provide a waterproof lamp string aiming at the shortcomings of the prior art. The waterproof lamp string is novel in structural design, simple in structure, convenient and quick to assemble, and replaceable in light source.

In order to achieve the above purpose, the present disclosure is realized by the following technical scheme.

A waterproof lamp string comprises an electric conductor, a lamp holder component, a light emitting source and a light-transmitting lamp shell, wherein the lamp holder component comprises a lamp holder main body and a lamp holder top cover provided at an upper end of the lamp holder main body, and the electric conductor transversely passes between the lamp holder main body and the lamp holder top cover;
a lower end of the lamp holder main body is provided with a light source mounting part, wherein a light source mounting hole which opens downwards is formed in the light source mounting part;
the lamp holder main body is provided with a metal terminal, an upper end of the metal terminal is provided with a spike part, a lower end of the metal terminal extends into the light source mounting hole, and the spike part of the metal terminal pierces a plastic sheath of the electric conductor and is in contact with and electrically connected with a conductor core of the electric conductor;
the light emitting source is inserted into the light source mounting hole of the light source mounting part, and an electric connection end of the light emitting source is in contact with and electrically connected with a lower end of the metal terminal;
a lamp holder top cover is fixed at the upper end of the lamp holder main body by ultrasonic sealing welding, and the electric conductor is hermetically clamped between the lamp holder main body and the lamp holder top cover;
a lower end of the lamp holder main body is further provided with a lamp shell connecting part, the lamp shell connecting part surrounds a periphery of the light source mounting part, the lamp shell connecting part, the light source mounting part and the lamp holder main body are integrated; an inner wall of the lamp shell connecting part is provided with an internal thread, an upper end of the light-transmitting lamp shell is provided with an external thread, and the external thread of the light-transmitting lamp shell is screwed with the internal thread of the lamp shell connecting part.

The light emitting source comprises a soft rubber core and a PCB board, a lower surface of the PCB board is provided with LED lamp beads, and the PCB board is welded with a light source pin;
a rubber core through hole which vertically penetrates is provided inside the soft rubber core, the light source pin penetrates through the rubber core through hole of the soft rubber core from bottom to top, a tail end of the light source pin is bent downwards to the position of a side wall of the soft rubber core, and the light source pin is in contact with and electrically connected with a lower end of the metal terminal.

An inner cavity of the light-transmitting lamp shell is provided with a lamp shell shoulder, and the lamp shell shoulder is located below the PCB board.

The side wall of the soft rubber core is provided with an alignment protrusion, an inner wall of the light source mounting hole is provided with an alignment groove, and the alignment protrusion is inserted into the alignment groove.

The metal terminal comprises a terminal shoulder, the spike part is provided at an upper edge part of the terminal shoulder, a lower edge part of the terminal shoulder is provided with a terminal strip part extending downward in a straight line, and the terminal shoulder, the spike part and the terminal strip part are integrated;
the lamp holder main body is provided with a terminal mounting hole corresponding to the metal terminal, the terminal shoulder of the metal terminal is embedded and limited in the terminal mounting hole, and the terminal strip part of the metal terminal extends into the light source mounting hole.

The inner wall of the light source mounting hole is provided with an inner wall T-shaped groove corresponding to the metal terminal, and the terminal strip part of the metal terminal is inserted and limited in the inner wall T-shaped groove.

The upper end of the lamp holder main body is provided with a conductor clamping slot which opens upwards and penetrates radially, a middle part of the lamp holder top cover is provided with a conductor clamping protrusion which protrudes downwards and whose shape is matched with that of the conductor clamping slot, and the electric conductor is hermetically clamped between a bottom surface of the conductor clamping slot and the conductor clamping protrusion.

The lamp holder top cover is provided with two positioning bosses which are arranged at intervals and protrude downwards, respectively, the lamp holder main body is provided with positioning grooves corresponding to each of the positioning bosses, respectively, and each of the positioning bosses of the lamp holder top cover is inserted into the positioning grooves corresponding to the lamp holder main body.

The lamp holder top cover is provided with a hook.

The waterproof lamp string according to the present disclosure has the following beneficial effects. The waterproof lamp string comprises an electric conductor, a lamp holder component, a light emitting source and a light-transmitting lamp shell. The lamp holder component comprises a lamp holder main body and a lamp holder top cover provided at an upper end of the lamp holder main body, and the electric conductor transversely passes between the lamp holder main body and the lamp holder top cover. A lower end of the lamp holder main body is provided with a light source mounting part, wherein a light source mounting hole which opens downwards is formed in the light source mounting part. The lamp holder main body is provided with a metal terminal, an upper end of the metal terminal is provided with a spike part, a lower end of the metal terminal extends into the light source mounting hole, and the spike part of the metal terminal pierces a plastic sheath of the electric conductor and is in contact with and electrically connected with a conductor core of the electric conductor. The light emitting source is inserted into the light source mounting hole of the light source mounting part, and an electric connection end of the light emitting source is in contact with and electrically connected with a lower end of the metal terminal. A lamp holder top cover is fixed at the upper end of the lamp holder main body by ultrasonic sealing welding, and the electric conductor is hermetically clamped between the lamp holder main body and the lamp holder top cover. A lower end of the lamp holder main body is further provided with a lamp shell connecting part, the lamp shell connecting part surrounds a periphery of the light source mounting part. The lamp shell connecting part, the light source mounting part and the lamp holder main body are integrated. An inner wall of the lamp shell connecting part is provided with an internal thread, an upper end of the light-transmitting lamp shell is provided with an external thread, and the external thread of the light-transmitting lamp shell is screwed with the internal thread of the lamp shell connecting part. Through the structural design, the present disclosure has the advantages of being novel in structural design, simple in structure, convenient and quick to assemble, and replaceable in light source.

### BRIEF DESCRIPTION OF DRAWINGS

The present disclosure will be further explained using the attached drawings, but the embodiments in the attached drawings do not constitute any restrictions on the present disclosure.

FIG. 1 is a schematic structural diagram of the present disclosure.

FIG. 2 is an exploded schematic diagram of the present disclosure.

FIG. 3 is a cross-sectional schematic diagram of the present disclosure.

FIG. 4 is a partially enlarged schematic diagram of FIG. 3.

FIG. 5 is a schematic structural diagram of a lamp holder main body according to the present disclosure.

FIG. 6 is a schematic structural diagram of a lamp holder main body according to the present disclosure from another perspective.

FIG. 7 is a schematic structural diagram of a lamp holder top cover according to the present disclosure.

FIG. 8 is a schematic structural diagram of a metal terminal according to the present disclosure.

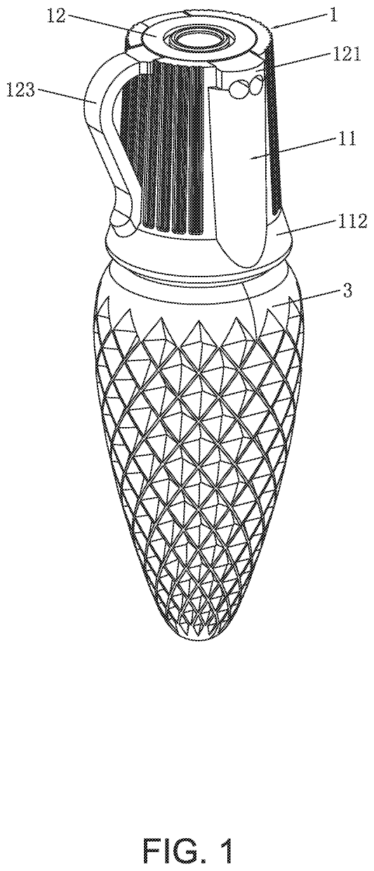

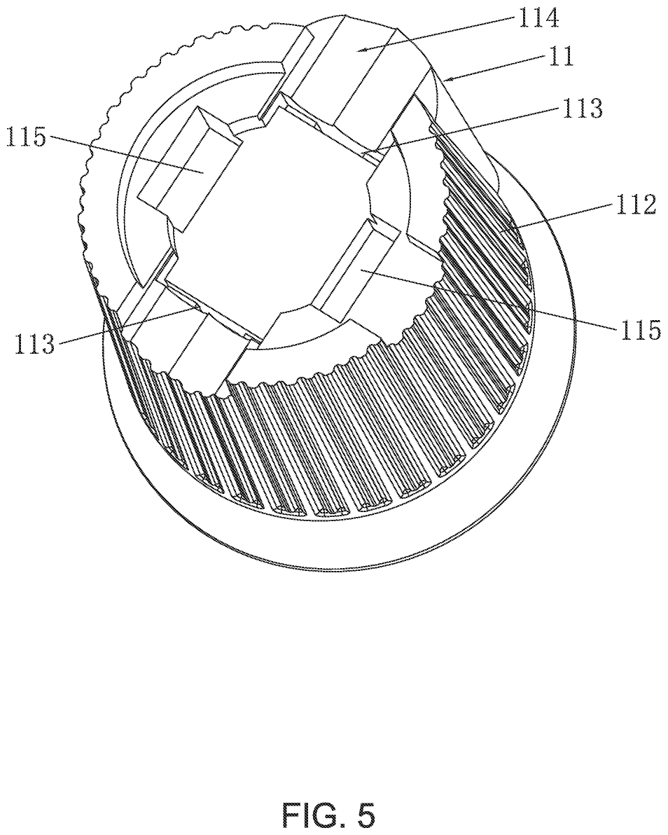

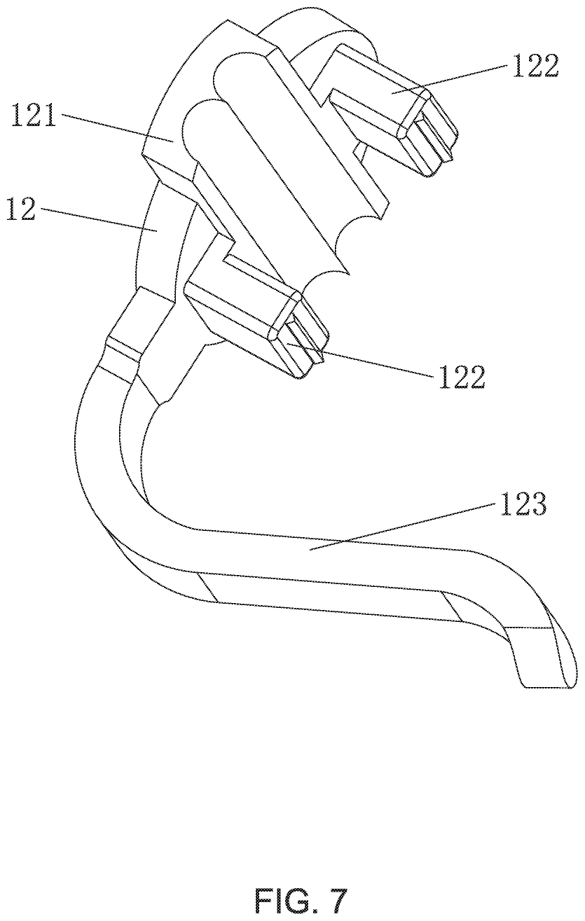

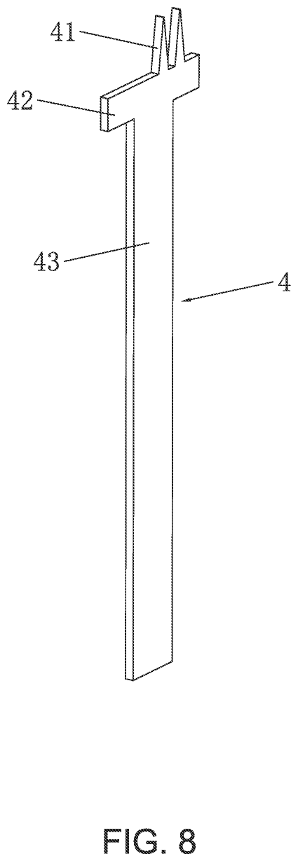

In FIGS. 1 to 8, there are:

1—lamp holder component; 11—lamp holder main body; 111—light source mounting part; 1111—light source mounting hole; 1112—alignment groove; 1113—inner wall T-shaped groove; 112—lamp shell connecting part; 1121—internal thread; 113—terminal mounting hole; 114—conductor clamping slot; 115—positioning groove; 12—lamp holder top cover; 121—conductor clamping protrusion; 122—positioning boss; 123—hook; 2—light emitting source; 21—soft rubber core; 211—rubber core through hole; 22—PCB board; 23—light source pin; 3—light-transmitting lamp shell; 31—external thread; 32—lamp shell shoulder; 4—metal terminal; 41—spike part; 42—terminal shoulder; 43—terminal strip part.

### DETAILED DESCRIPTION

The present disclosure will be described hereinafter with reference to specific embodiments.

Embodiment 1 is shown in FIGS. 1 to 4. A waterproof lamp string is provided, which comprises an electric conductor (not shown in the figures), a lamp holder component 1, a light emitting source 2 and a light-transmitting lamp shell 3. The lamp holder component 1 comprises a lamp holder main body 11 and a lamp holder top cover 12 provided at an upper end of the lamp holder main body 11. The electric conductor transversely passes between the lamp holder main body 11 and the lamp holder top cover 12.

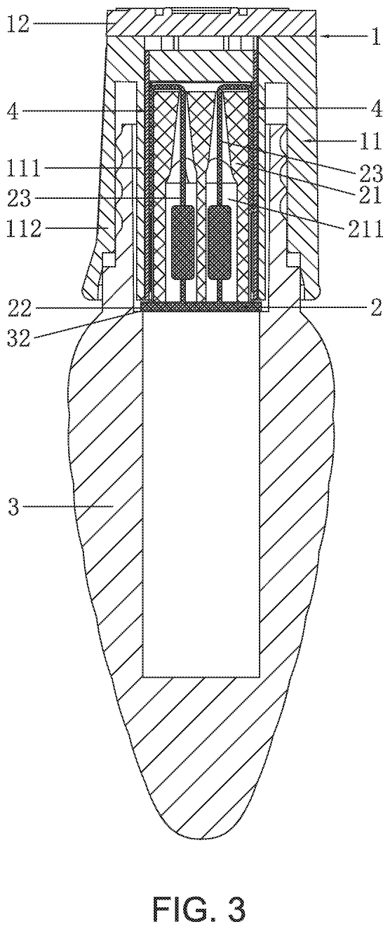

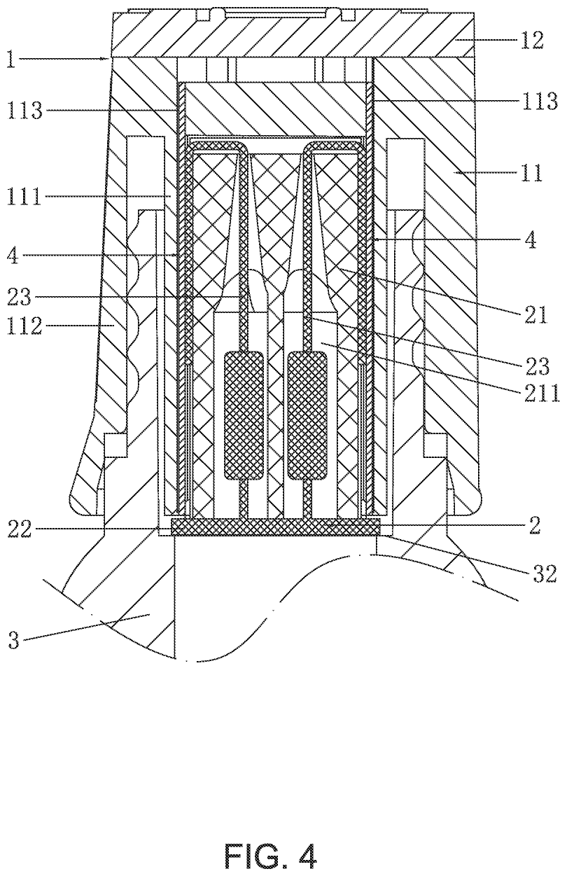

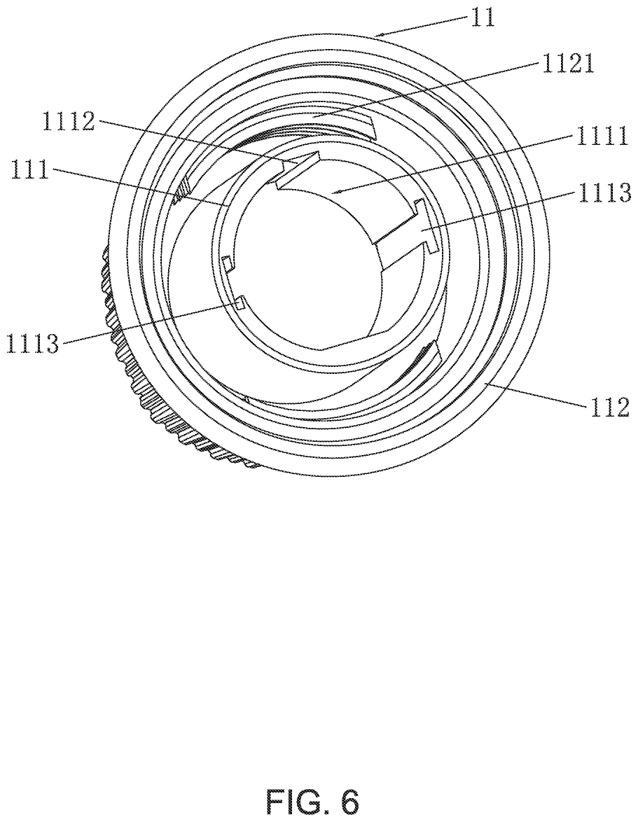

As shown in FIG. 3, FIG. 4 and FIG. 6, a lower end of the lamp holder main body 11 is provided with a light source mounting part 111. A light source mounting hole 1111 which opens downwards is formed in the light source mounting part 111.

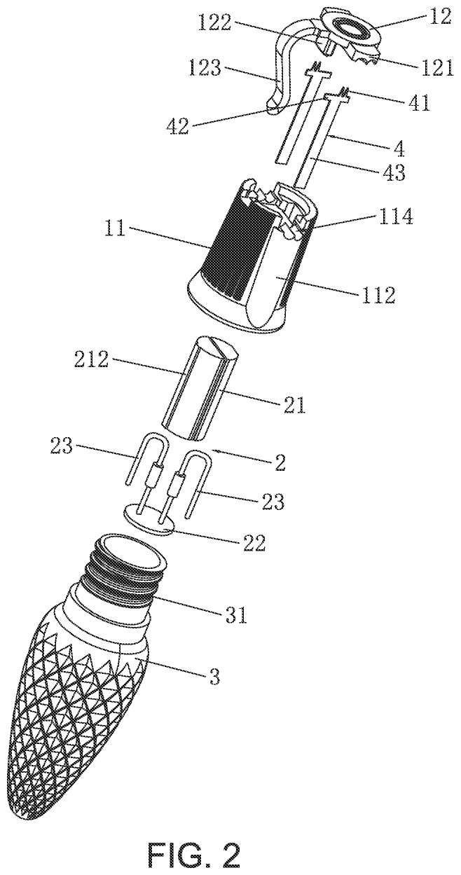

Further, as shown in FIGS. 2 to 4, the lamp holder main body 11 is provided with a metal terminal 4. An upper end of the metal terminal 4 is provided with a spike part 41. A lower end of the metal terminal 4 extends into the light source mounting hole 1111, and the spike part 41 of the metal terminal 4 pierces a plastic sheath of the electric conductor and is in contact with and electrically connected with a conductor core of the electric conductor. The light emitting source 2 is inserted into the light source mounting hole 1111 of the light source mounting part 111, and an electric connection end of the light emitting source 2 is in contact with and electrically connected with a lower end of the metal terminal 4.

Furthermore, a lamp holder top cover 12 is fixed at the upper end of the lamp holder main body 11 by ultrasonic sealing welding, and the electric conductor is hermetically clamped between the lamp holder main body 11 and the lamp holder top cover 12.

In addition, a lower end of the lamp holder main body 11 is further provided with a lamp shell connecting part 112, the lamp shell connecting part 112 surrounds a periphery of the light source mounting part 111, the lamp shell connecting part 112, the light source mounting part 111 and the lamp holder main body 11 are integrated. An inner wall of the lamp shell connecting part 112 is provided with an internal thread 1121, an upper end of the light-transmitting lamp shell 3 is provided with an external thread 31, and the external thread 31 of the light-transmitting lamp shell 3 is screwed with the internal thread 1121 of the lamp shell connecting part 112.

In the process of assembling the waterproof lamp string in Embodiment 1, first, the light emitting source 2 is embedded in the light source mounting hole 1111 of the light source mounting part 111 of the lamp holder main body 11, and then the metal terminal 4 is mounted on the lamp holder main body 11 so that the metal terminal 4 is in contact with and electrically connected with the electric connection end of the light emitting source 2. Thereafter, the electrical conductor is placed on the lamp holder main body 11, and the lamp holder top cover 12 mounted, so that the electrical conductor is clamped between the lamp holder main body 11 and the lamp holder top cover 12. In this process, the spike part 41 of the metal terminal 4 pierces the plastic sheath of the electric conductor and is in contact with and electrically connected with the conductor core of the electric conductor. After the mounting of the lamp holder top cover 12 is completed, the lamp holder top cover 12 and the lamp holder main body 11 are ultrasonically welded and sealed by ultrasonic welding. At this time, the electric conductor is hermetically clamped between the lamp holder main body 11 and the lamp holder top cover 12, and the contact position between the lamp holder top cover 12 and the lamp holder main body 11 is welded and sealed. After the ultrasonic sealing welding of the lamp holder top cover 12 is completed, the light-transmitting lamp shell 3 is serewed to the lamp shell connecting part 112 of the lamp holder main body 11 to complete the assembly of the whole waterproof lamp string.

It should be pointed out that, for the waterproof lamp string in Embodiment 1, the lamp holder top cover 12 and the lamp holder main body 11 are hermetically connected by ultrasonic welding, and the electric conductor is hermetically clamped between the lamp holder top cover 12 and the lamp holder main body 11. The waterproof structure design can effectively realize the sealing and waterproofing of the upper position of the lamp holder main body 11.

In addition, the light-transmitting lamp shell 3 of Embodiment 1 is screwed to the lamp shell connecting part 112 of the lamp holder main body 11. The connecting structure of the external thread 31 and the internal thread 1121 between the light-transmitting lamp shell 3 and the lamp shell connecting part 112 can realize the waterproofing between the lamp holder top cover and the lamp shell.

It should be further emphasized that the light emitting source 2 of Embodiment 1 is mounted in the light source mounting hole 1111 of the light source mounting part 111 in a plug-in manner, that is, the light emitting source 2 has a pluggable structure. When in use, a user can plug and replace the light emitting source 2 according to the use requirements, so as to replace the light source. In addition, the plug-in manner of the light emitting source 2 also has the advantages of convenient and quick assembly.

Based on the above situation, it can be seen that through the above structural design, the waterproof lamp string in Embodiment 1 has the advantages of being novel in structural design, simple in structure, convenient and quick to assemble, and replaceable in light source.

Embodiment 2 is shown in FIGS. 2 to 4. Embodiment 2 is different from Embodiment 1 in that the light emitting source 2 comprises a soft rubber core 21 and a PCB board 22. A lower surface of the PCB board 22 is provided with LED lamp beads (not shown in the figures), and the PCB board 22 is welded with a light source pin 23.

A rubber core through hole 211 which vertically penetrates is provided inside the soft rubber core 21. The light source pin 23 penetrates through the rubber core through hole 211 of the soft rubber core 21 from bottom to top. A tail end of the light source pin 23 is bent downwards to the position of a side wall of the soft rubber core 21, and the light source pin 23 is in contact with and electrically connected with a lower end of the metal terminal 4.

The PCB board 22 of Embodiment 2 is fixed to the soft rubber core 21 after being bent by the light source pins 23. The soft rubber core 21 has a certain elastic deformation ability. When the light emitting source 2 is embedded in the light source mounting part 111 of the lamp holder main body 11, the side wall of the soft rubber core 21 is abutted against the inner wall of the light source mounting hole 1111, so that the soft rubber core 21 is stably embedded in the light source mounting hole 1111.

Embodiment 3 is shown in FIGS. 3 and 4. Embodiment 3 is different from Embodiment 2 in that an inner cavity of the light-transmitting lamp shell 3 is provided with a lamp shell shoulder 32, and the lamp shell shoulder 32 is located below the PCB board 22.

The lamp shell shoulder 32 of Embodiment 3 can limit the light emitting source 2 to prevent the light emitting source 2 from sliding down from the light source mounting hole 1111 when in use.

Embodiment 4 is shown in FIGS. 2 and 6. Embodiment 4 is different from Embodiment 2 in that the side wall of the soft rubber core 21 is provided with an alignment protrusion, an inner wall of the light source mounting hole 1111 is provided with an alignment groove 1112, and the alignment protrusion is inserted into the alignment groove 1112.

When the light emitting source 2 is embedded in the light source mounting hole 1111 of the light source mounting part 111, the alignment protrusion of the soft rubber core 21 is matched with the alignment groove 1112 of the inner wall of the light source mounting hole 1111, so that workers can realize the quick centering mounting of the soft rubber core 21 and effectively ensure the accuracy of mounting the light emitting source 2.

Embodiment 5 is shown in FIGS. 2, 3, 4 and 8. Embodiment 5 is different from Embodiment 1 in that the metal terminal 4 comprises a terminal shoulder 42, the spike part 41 is provided at an upper edge part of the terminal shoulder 42, a lower edge part of the terminal shoulder 42 is provided with a terminal strip part 43 extending downward in a straight line, and the terminal shoulder 42, the spike part 41 and the terminal strip part 43 are integrated.

The lamp holder main body 11 is provided with a terminal mounting hole 113 corresponding to the metal terminal 4, the terminal shoulder 42 of the metal terminal 4 is embedded and limited in the terminal mounting hole 113, and the terminal strip part 43 of the metal terminal 4 extends into the light source mounting hole 1111.

It should be noted that the metal terminal 4 of Embodiment 5 may be a copper terminal.

Embodiment 6 is shown in FIG. 6. Embodiment 6 is different from Embodiment 5 in that the inner wall of the light source mounting hole 1111 is provided with an inner wall T-shaped groove 1113 corresponding to the metal terminal 4, and the terminal strip part 43 of the metal terminal 4 is inserted and limited in the inner wall T-shaped groove 1113.

After the metal terminal 4 is mounted on the lamp holder main body 11, the terminal strip part 43 of the metal terminal 4 is inserted and positioned in the inner wall T-shaped groove 1113. The inner wall T-shaped groove 1113 can effectively ensure that the position of the terminal strip part 43 of the metal terminal 4 is fixed and effectively avoid the deformation of the terminal strip part 43, thus ensuring the stability and reliability when the metal terminal 4 is in in contact with and electrically connected with the light source pin 23 of the light emitting source 2.

Embodiment 7 is shown in FIGS. 1, 2, 5 and 7. Embodiment 7 is different from Embodiment 1 in that the upper end of the lamp holder main body 11 is provided with a conductor clamping slot 114 which opens upwards and penetrates radially, a middle part of the lamp holder top cover 12 is provided with a conductor clamping protrusion 121 which protrudes downwards and whose shape is matched with that of the conductor clamping slot 114, and the electric conductor is hermetically clamped between a bottom surface of the conductor clamping slot 114 and the conductor clamping protrusion 121.

For the waterproof lamp string of Embodiment 7, the conductor clamping protrusion 121 is matched with the conductor clamping groove, so that on the one hand, the lamp holder top cover 12 and the lamp holder main body 11 can be stably and reliably clamped and fixed with the electric conductor, and on the other hand, the waterproof sealing performance of the position of the electric conductor can be effectively ensured.

Embodiment 8 is shown in FIGS. 2, 5 and 7. Embodiment 8 is different from Embodiment 1 in that the lamp holder top cover 12 is provided with two positioning bosses 122 which are arranged at intervals and protrude downwards, respectively, the lamp holder main body 11 is provided with positioning grooves 115 corresponding to each of the positioning bosses 122, respectively, and each of the positioning bosses 122 of the lamp holder top cover 12 is inserted into the positioning grooves 115 corresponding to the lamp holder main body 11.

When the lamp holder top cover 12 is mounted on the upper end of the lamp holder main body 11, the positioning boss 122 is matched with the positioning groove 115, so that the lamp holder top cover 12 of Embodiment 8 can be quickly centered to improve the convenience of assembly.

Embodiment 9 is shown in FIGS. 1, 2 and 7. Embodiment 9 is different from Embodiment 1 in that the lamp holder top cover 12 is provided with a hook 123. When in use, the hook 123 can play the role of convenient hanging and fixing.

The above content is only the preferred embodiment of the present disclosure. For those skilled in the art, there will be changes in the specific implementation and application scope according to the idea of the present disclosure, and the content of this specification should not be understood as a limitation on the present disclosure.

What is claimed is:

1. A waterproof lamp string, comprising an electric conductor, a lamp holder component (1), a light emitting source (2) and a light-transmitting lamp shell (3), wherein the lamp holder component (1) comprises a lamp holder main body (11) and a lamp holder top cover (12) provided at an upper end of the lamp holder main body (11), and the electric conductor transversely passes between the lamp holder main body (11) and the lamp holder top cover (12);
a lower end of the lamp holder main body (11) is provided with a light source mounting part (111), wherein a light source mounting hole (1111) which opens downwards is formed in the light source mounting part (111);
the lamp holder main body (11) is provided with a metal terminal (4), an upper end of the metal terminal (4) is provided with a spike part (41), a lower end of the metal terminal (4) extends into the light source mounting hole (1111), and the spike part (41) of the metal terminal (4) pierces a plastic sheath of the electric conductor and is in contact with and electrically connected with a conductor core of the electric conductor;
the light emitting source (2) is inserted into the light source mounting hole (1111) of the light source mounting part (111), and an electric connection end of the light emitting source (2) is in contact with and electrically connected with a lower end of the metal terminal (4);
a lamp holder top cover (12) is fixed at the upper end of the lamp holder main body (11) by ultrasonic sealing welding, and the electric conductor is hermetically clamped between the lamp holder main body (11) and the lamp holder top cover (12);
a lower end of the lamp holder main body (11) is further provided with a lamp shell connecting part (112), the lamp shell connecting part (112) surrounds a periphery of the light source mounting part (111), the lamp shell connecting part (112), the light source mounting part (111) and the lamp holder main body (11) are integrated; an inner wall of the lamp shell connecting part (112) is provided with an internal thread (1121), an upper end of the light-transmitting lamp shell (3) is provided with an external thread (31), and the external thread (31) of the light-transmitting lamp shell (3) is screwed with the internal thread (1121) of the lamp shell connecting part (112).

2. The waterproof lamp string according to claim 1, wherein the light emitting source (2) comprises a soft rubber core (21) and a PCB board (22), a lower surface of the PCB board (22) is provided with LED lamp beads, and the PCB board (22) is welded with a light source pin (23);
a rubber core through hole (211) which vertically penetrates is provided inside the soft rubber core (21), the light source pin (23) penetrates through the rubber core through hole (211) of the soft rubber core (21) from bottom to top, a tail end of the light source pin (23) is bent downwards to the position of a side wall of the soft rubber core (21), and the light source pin (23) is in contact with and electrically connected with a lower end of the metal terminal (4).

3. The waterproof lamp string according to claim 2, wherein an inner cavity of the light-transmitting lamp shell (3) is provided with a lamp shell shoulder (32), and the lamp shell shoulder (32) is located below the PCB board (22).

4. The waterproof lamp string according to claim 2, wherein the side wall of the soft rubber core (21) is provided with an alignment protrusion, an inner wall of the light source mounting hole (1111) is provided with an alignment groove (1112), and the alignment protrusion is inserted into the alignment groove (1112).

5. The waterproof lamp string according to claim 1, wherein the metal terminal (4) comprises a terminal shoulder (42), the spike part (41) is provided at an upper edge part of the terminal shoulder (42), a lower edge part of the terminal shoulder (42) is provided with a terminal strip part (43) extending downward in a straight line, and the terminal shoulder (42), the spike part (41) and the terminal strip part (43) are integrated;
the lamp holder main body (11) is provided with a terminal mounting hole (113) corresponding to the metal terminal (4), the terminal shoulder (42) of the metal terminal (4) is embedded and limited in the terminal mounting hole (113), and the terminal strip part (43) of the metal terminal (4) extends into the light source mounting hole (1111).

6. The waterproof lamp string according to claim 5, wherein the inner wall of the light source mounting hole (1111) is provided with an inner wall T-shaped groove (1113) corresponding to the metal terminal (4), and the terminal strip part (43) of the metal terminal (4) is inserted and limited in the inner wall T-shaped groove (1113).

7. The waterproof lamp string according to claim 1, wherein the upper end of the lamp holder main body (11) is provided with a conductor clamping slot (114) which opens upwards and penetrates radially, a middle part of the lamp holder top cover (12) is provided with a conductor clamping protrusion (121) which protrudes downwards and whose shape is matched with that of the conductor clamping slot (114), and the electric conductor is hermetically clamped between a bottom surface of the conductor clamping slot (114) and the conductor clamping protrusion (121).

8. The waterproof lamp string according to claim 1, wherein the lamp holder top cover (12) is provided with two positioning bosses (122) which are arranged at intervals and protrude downwards, respectively, the lamp holder main body (11) is provided with positioning grooves (115) corresponding to each of the positioning bosses (122), respectively, and each of the positioning bosses (122) of the lamp holder top cover (12) is inserted into the positioning grooves (115) corresponding to the lamp holder main body (11).

9. The waterproof lamp string according to claim 1, wherein the lamp holder top cover (12) is provided with a hook (123).
